(19) United States
(12) Patent Application Publication
(10) Pub. No.: US 2005/0210122 A1
(43) Pub. Date: Sep. 22, 2005

(54) HTTP acceleration over a network link

(75) Inventors: Kirk Steven Taylor, San Diego, CA (US); Ricardo Jorge Lopez, San Marcos, CA (US); Jack Steenstra, San Diego, CA (US)

Correspondence Address: Qualcomm Incorporated;Patents Department, 5775 Morehouse Drive, San Diego, CA, 92121-1714, US

(73) Assignee: QUALCOMM Incorporated

(21) Appl. No.: 10/931,310

(22) Filed: Aug. 31, 2004

Related U.S. Application Data
(60) Provisional application No. 60/555,605, filed on Mar. 22, 2004.

(51) Int. Cl. G06F 15/16

(52) U.S. Cl. 709/218; 709/245

(57) ABSTRACT

A method and apparatus for downloading a hyper text transfer protocol (HTTP) web page over a wireless link that couples a modem to a gateway. A transmission control protocol (TCP) link is opened between the gateway and the modem. A HTTP uniform resource identifier (URI) is received at the modem from a web browser, where the HTTP URI corresponds to the HTTP web page of an origin server. The TCP link is configured well before the web browser provides the URI. The HTTP URI is sent to the gateway. An Internet protocol (IP) address is determined for a domain name indicated in the HTTP URI by the gateway. The HTTP web page is retrieved by the gateway using the Internet, without the modem requesting it. The HTTP web page is transmitted to the satellite modem. Objects referenced in the HTTP web page are accessed similarly to the HTTP web page, but objects can also be accessed in parallel. In some cases, bandwidth is scaled for the TCP link according to loading of the modem.

This application claims the benefit of and is a non-provisional of U.S. Application Ser. No. 60/555,605 filed on Mar. 22, 2004, which is incorporated by reference in its entirety.

This application is related to U.S. patent application Ser. No. ______, filed on the same date as the present application, entitled “SATELLITE ANTICIPATORY BANDWIDTH ACCELERATION” (referenced by Attorney Docket No. 040366), which is incorporated by reference in its entirety.

### BACKGROUND OF THE DISCLOSURE

This disclosure relates in general to broadband optimization and, more specifically, but not by way of limitation, to HTTP optimization over a high-latency datalink.

A broadband geosynchronous satellite imposes a propagation delay to any transport of approximately 250 ms. This has the obvious implication that any communication on the part of a sender is delayed a quarter second before a receiver can react to and respond to the given communication. The TCP/IP protocol requires a bi-directional interaction between sender and receiver. This creates approximately 500 ms round trip time (RTT) in which a receiver is able to acknowledge (and possibly respond to) a sender's communication.

It can be claimed that all of the difficulties experienced with the use of a broadband geosynchronous satellite can be traced back to this root cause of its relatively large propagation delay. The effect of the delay is magnified by a style of protocol that requires synchronization between sender and receiver of increasingly small elements of a user interaction, such as a www browsing request.

A user invokes a WWW transaction through the services of a software component known as a browser, such as Internet Explorer™ or Netscape Navigator™ as examples. The browser will interact with another software component known as a web server application (e.g., Apache™) that runs on an origin server. The interaction proceeds over the Internet using both UDP and TCP protocols for various elements of the overall transaction. The transaction may be decomposed into five distinct classes of sub-transactions. These are one or more DNS transactions, connection establishment transactions (i.e., SYN, SYN-ACK, ACK), HTTP transactions, TCP transfer transactions, and connection tear down transactions (i.e., FIN, FIN-ACK, ACK).

The term transaction here is being used with the implication that a transaction is an independent interaction that is both closed (i.e., has begin and end states) and consistent (i.e., begin and end states are valid states for the context). For a transaction to be closed over a communications link requires at least one sender-receiver interchange. For a broadband geosynchronous satellite, this implies a minimum of approximately 500 ms transaction time, which is the time in which the transaction remains open.

One important aspect of world wide web (WWW) transactions is the serial nature of several of the composing sub-transactions. The implication that one transaction cannot be started until a previous transaction is ended deprives the overall transaction of inherent parallelism. This is not to say that any sub-transactions are serialized with all the other sub-transactions, there are in fact many opportunities for parallelism in some cases of HTTP transactions and in most case of the TCP transfer transactions.

A WWW transaction begins with a request to retrieve an universal resource locator (URL) that includes a host name. The host name revolves to an IP address using DNS lookup services. No further portion of the WWW transaction becomes burdensome when one considers that many embedded objects in a main page include references to URLs having distinct host names requiring their own DNS lookups. In addition, DNS as a simple stateless query/reply protocol handles packet loss a the application layer by using a fixed timeout followed by the retransmission of the original query. The timeout, frequently being set to one second, can impose a delay burden if the initial DNS query (or reply) is lost.

The HTTP protocol uses TCP as the underlying transport protocol. TCP itself is a connection-oriented protocol, which requires connection establishment at the beginning of a TCP connection. This connection establishment is a 3-way handshake that requires at least one RTT to complete. Should a packet be lost in the 3-way handshake, default timers—measured in seconds, must expire before a retransmission can be sent. Here too, as in DNS lookup, packet loss can impose a significant delay burden.

A typical WWW transaction will generate many HTTP GET requests for objects embedded in the main web page. These requests are often targeted to distinct servers usually with one or more servers serving the bulk of the requests. The HTTP 1.0 specification, RFC 1945, and the HTTP 1.1 specification, RFC 2616, recommend 4 and 2 maximum simultaneous TCP connections per server respectively.

A browser may queue up many requests to a single server served by only these 2 or 4 connections. Each request is completed before the next is sent. Thus, the minimum delay burden (in RTTs of course) is the number of objects to be fetched divided by the number of simultaneous connections. It follows that for large number of embedded objects, this delay burden can be quite significant. Given, as an example, the Amazon™ web page with approximately 40 embedded objects, located on one server, would require more than 10 (or 20) RTTs to fetch all the embedded objects.

Mutual benefit comes of the avoidance of TCP traffic congestion on the Internet. For this reason a TCP session begins transport, or continues transport after an idle period, using a procedure known as “slow-start.” Additionally, the congestion window—the maximum number of unacknowledged segments outstanding—reduces the maximum throughput to the window size divided by the RTT. In the case of a broadband geosynchronous satellite, that throughput is generally limited to two times the window size.

Slow-start allows the load, in segments, to increase steadily from an initial load, required by RFC 2581 to be no more than 2 segments. Certainly for links with a high RTT, Slow-start can be a very heavy delay burden, as each ACK cycle only allows the load to increase by a single segment. The time to reach full utilization of the link can be quite significant where the RTT and bandwidth are large. The time to fetch medium to large size web pages (i.e., 10 to 100 Kilobytes) are increased by the TCP slow start phase of the transfer. In fact, for such transfers, the throughput is dominated by this slow start phase.

It should be noted that low bandwidth links (less than 128 kbps) introduce measurable transmission delay. For large objects transported over such links, the portion of the overall transaction delay ascribed to transmission delay becomes more significant. Using the previous example of the Amazon™ web page, the total size of all the GET requests is on the order of 30 Kilobytes. Using a return link transmission rate of approximately 30 kbps, for example, can add eight seconds to the overall transaction delay.

As previously stated, TCP is a connection oriented protocol, and as such requires connections to be established when needed and torn down when no longer necessary. As it happens, in both the HTTP 1.0 & 1.1 specifications, servers may request a client to close their connection. When this occurs, as always does for HTTP 1.0, the connection must proceed through session teardown. Like session initiation, session teardown is a 3-way handshake also requiring at least on RTT to complete.

What is of importance in the case of session teardown is that the browser cannot establish a new connection with a given server in excess of the specifications for simultaneous connections. As such, the delay burden is experienced only when issuing multiple connection requests to the same server for which a session is being torn down.

Proxies, by definition, act on behalf of another entity. They are within the software industry understood to be a class of software agent. They can be placed near or far in relationship to the entity they proxy for. They may also be distributed among several places between the entity they serve and the entity with which they interact on behalf of those they serve. Proxies can be grouped into those that are transparent to their clients (i.e., an implicit proxy) or non-transparent to their clients (i.e., an explicit proxy). Furthermore, they can be broadly categorized as an API proxy or as a protocol proxies that are distinguished by the protocol—be it at the application, presentation, session, or transport layers—that they realize on behalf of their client.

It is not uncommon for either an API proxy or a protocol proxy to make use of a technique known as caching to support the clients they serve. Such proxies invariably have to deal with the implications of cache coherence and replication. In some cases a proxy may prioritize the avoidance of transport delay over the need, as in a broadband satellite link, to avoid adding synchronized transactional elements. The best example for this approach is in adding synchronized transactional elements. One example for this approach is in the HTTP proxies that employ Internet communications protocol (ICP) to maintain cache coherency.

ICP, which can substantially reduce the amount of data actually transported over an HTTP connection, actually has a devastating impact on user experience latency (UEL) over a broadband satellite link, because it adds synchronized transactional elements in order to achieve the reduction in data transported over the connection.

A DNS proxy (as in local DNS Server) locates a subset of all DNS Servers closer to the querying client. This has the implication of shortening the DNS lookup transaction from the client's perspective. A DNS proxy uses the technique of maintaining a cache to hold previously obtained answers for future queries.

A TCP proxy or SOCKS proxy offers an explicit means of delegating all of a client's connections to the TCP proxy. This has the implication of serving the association of the client (or clients) from the actual interchange. It allows for connection parameters to be established in a uniform way by the proxy, independent of the client the connection serves.

An HTTP proxy offers an explicit means of delegating all of a client's HTTP (and therefore TCP) transactions to the HTTP proxy. This has the implication of both shortening the overall transaction as well as hiding the parameters and qualities of the underlying connections of the transactional elements that serve the WWW transaction (including DNS lookup).

### BRIEF SUMMARY OF THE DISCLOSURE

This disclosure relates to accelerating broadband wireless links by reducing the interaction required to obtain an HTTP web page. In one embodiment, the wireless link includes a geosynchronous satellite that introduces about 250 ms of delay or latency. The latency of the satellite link is reduced by having an HTTP processor in the user's satellite modem and a HTTP fetcher in the satellite gateway or basestation. By knowing a particular URI is a HTTP type request, the initial HTTP web page can be requested by the satellite modem from the wireless gateway in a single communication. The embedded objects of the HTTP web page can be requested in parallel such that only a single RTT is required for all of the embedded objects. This reduces the multiple round-trip delays required by conventional systems.

In one embodiment, a TCP or other link is configured well in advance of receiving the HTTP web page request. Once the HTTP processor receives the HTTP web page request, it is forwarded over the wireless link to the wireless gateway. The HTTP fetcher in the wireless gateway performs a DNS look up to find the IP address of the domain indicated in the HTTP web page request. Once the IP address is known, the initial web page containing links to embedded objects is requested by the wireless gateway without requiring further action by the wireless modem. The initial web page is forwarded to the wireless modem using the configured TCP link. The embedded objects of the initial web page can be requested in a parallel fashion to receive them in about one RTT.

There are various other aspects to the disclosure. For example, either the wireless modem and/or the wireless gateway could include a DNS cache and/or an HTTP cache. As another example, the HTTP web page request could be compressed over the wireless link. Some embodiments could use either a satellite and/or a cellular base station in the wireless link.

The topology of the wireless broadband system indicates asymmetric datalink, for example, a 3 Mbps downlink forward channel and 5-40 Kbps uplink return channel. The relatively limited uplink bandwidth is scalable according to need. A minimal return channel (i.e., a few kilobits per second or more) is always available to each satellite modem regardless of it being used, which allows low-latency requests by avoiding bandwidth request transactions over the satellite link. Once a particular modem uplinks data in that return channel, it can request allocation of more bandwidth. The satellite gateway, bandwidth permitting, can give the satellite modem authorization to scale up the bandwidth of the uplink according to the current need.

In one aspect of the disclosure, the return channel can use compression to overcome transmission delays incurred by a low bandwidth return channel (as discussed above). The compression could be tailored for the type of information sent on the return channel. For example, HTTP requests could use a text specific algorithm to effectively increase the data carrying capacity of the relatively limited uplink bandwidth.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A and 1B are block diagrams of embodiments of a wireless broadband system;

FIGS. 2A, 2B, 2C, and 2D are block diagrams of embodiments of a satellite modem;

FIGS. 3A and 3B are block diagrams of embodiments of a satellite gateway;

FIGS. 4A, 4B and 4C are flow diagrams of embodiments of a process for downloading HTTP objects over a wireless link; and

FIGS. 5A and 5B are flow diagrams of embodiments of a process for accelerating a return link.

### DESCRIPTION OF THE SPECIFIC EMBODIMENTS

The present disclosure provides embodiments mitigate or eliminate problems of World Wide Web (WWW) browsing over a broadband satellite or other high-latency data link. One of the problems addressed by the embodiments is the reduction of user-experienced latency. In the following description, specific details are given to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process which is depicted as a flowchart, a flow diagram, a structure diagram, or a block diagram. Although a flowchart may describe the operations as a sequential process, many of the operations can be performed in parallel or concurrently. In addition, the order o the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine readable medium such as storage medium. A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

With an appreciation of the problem analysis and the fundamental implications of a broadband satellite link, the embodiments described endeavor to mask or mitigate the inherent problems found in each of the underlying sub-transactions of the overall WWW transaction.

The DNS Sub-Transaction

The DNS sub-transaction can be mitigated as well as masked using at least two distinct techniques in various embodiments. The first technique, which mitigates the cost of the DNS sub-transaction, is a client side DNS Cache Proxy. This proxy caches previously acquired answers with long time to live (i.e., expiration time). When a given query is re-issued, the original delay burden is amortized over every re-submittal.

The second technique, which masks the cost of several of the sub-transactions within a WWW transaction, including the DNS sub-transaction, includes a client side HTTP processor served by a terrestrial side HTTP fetcher. The HTTP processor essentially distributes the entire DNS sub-transaction to the HTTP fetcher, thereby eliminating the implications of the broadband satellite link on the DNS sub-transaction. Further, the session initiation and session teardown TCP sub-transactions can be mitigated as well. These two techniques save one or more broadband satellite link round trip times (RTTs) and replaces them with terrestrial RTTs.

The Session-Initiation and Session-Teardown Sub-Transactions

These two sub-transactions can be mitigated by using a client side HTTP processor served by a terrestrial side HTTP fetcher. Here the cost of these sub-transactions is entirely masked, as the client browser establishes its relationship with the client side HTTP processor, and can be open and closed as needed. However, the connection between the HTTP processor and HTTP fetcher is maintained indefinitely (very long timeout). This technique eliminates the broadband satellite link RTTs required for setting up and tearing down TCP connections and replaces them with a single TCP set up and tear down between the HTTP processor of the satellite modem and the HTTP fetcher in the gateway component.

The HTTP Sub-Transaction (GET/REPLY Serialization)

HTTP GET/REPLY serialization results from the constraints the RFC standards impose. Most browsers adhere to these constraints. HTTP GET/REPLY serialization can be mitigated using two related techniques.

The first technique, which mitigates the HTTP GET/REPLY serialization impact for HTTP 1.0 transaction is to use parallel TCP connections from the browser to the client-side HTTP processor in the satellite modem. This technique is additionally available to HTTP 1.1 transaction, but subject to the connection limit specified in the RFCs. It should be noted here that the RFCs impose a diminutive connection limit on the client browser. The client-side HTTP processor and its terrestrial HTTP fetcher are implemented to support a reasonably open ended number of simultaneous connections.

The second technique, which mitigates HTTP GET/REPLY serialization impact for HTTP 1.1 transaction is to support GET pipelining in the HTTP processor and HTTP fetcher for HTTP 1.1 browsers that implement pipelining. Both of these technique can reduce serialization effects for especially large sites with a large number of embedded objects. Additionally, these two techniques can be used together.

By removing the serialization of HTTP GET/REPLYs via one of these two methods the access to all objects in this embodiment can be reduced to about one or two total broadband satellite link delays instead of nearly one for every object.

The TCP Transport Sub-Transaction

The impact that the broadband satellite link has on TCP transport can be mitigated using two techniques. The first technique, nullifies the effect of the RTT on throughput by permitting a window of 750 Kilobytes. This, in conjunction with the second technique listed below, allows the link to reach full utilization nearly instantly.

The second technique, mitigates slow-start from the TCP stack. This is justified by the fact that between the two end-points there is only the satellite link, which does not suffer link congestion. These modifications of TCP's operation can remove several broadband satellite link round trips from the transfer of a requested object in an HTTP transaction.

The Transmission Delay Implication (GET/REPLY Size)

Using data compression on both the HTTP GET and HTTP REPLY can mitigate the impact of transmission delay on the HTTP transaction. Analysis of the content of the HTTP GET and REPLY for many sites shows that the compression ratio achievable for the HTTP GET is nearly 90% or better and the compression ratio achievable for the HTTP REPLY is approximately 50% or better. This high data compression ratio, especially for HTTP GETs on the return link, can save significant time when low speed return link rates are implemented for other system design purposes. Any type of compression algorithm that is effective on text data could be used, for example, Lempel-Ziv compression.

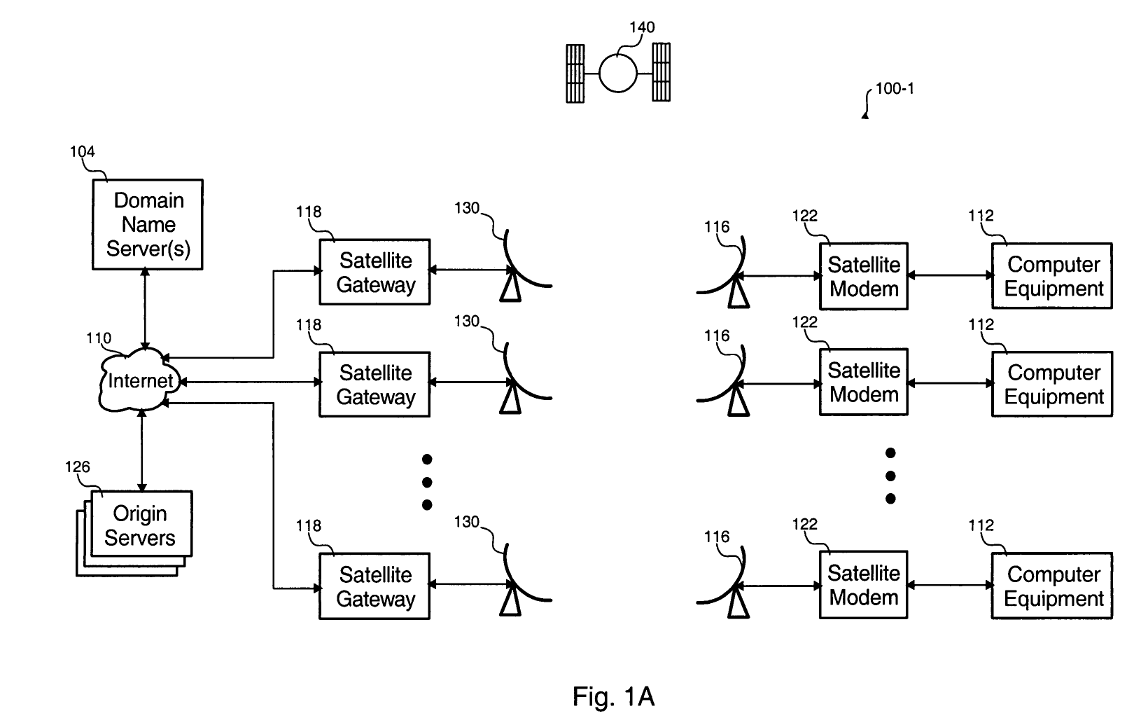

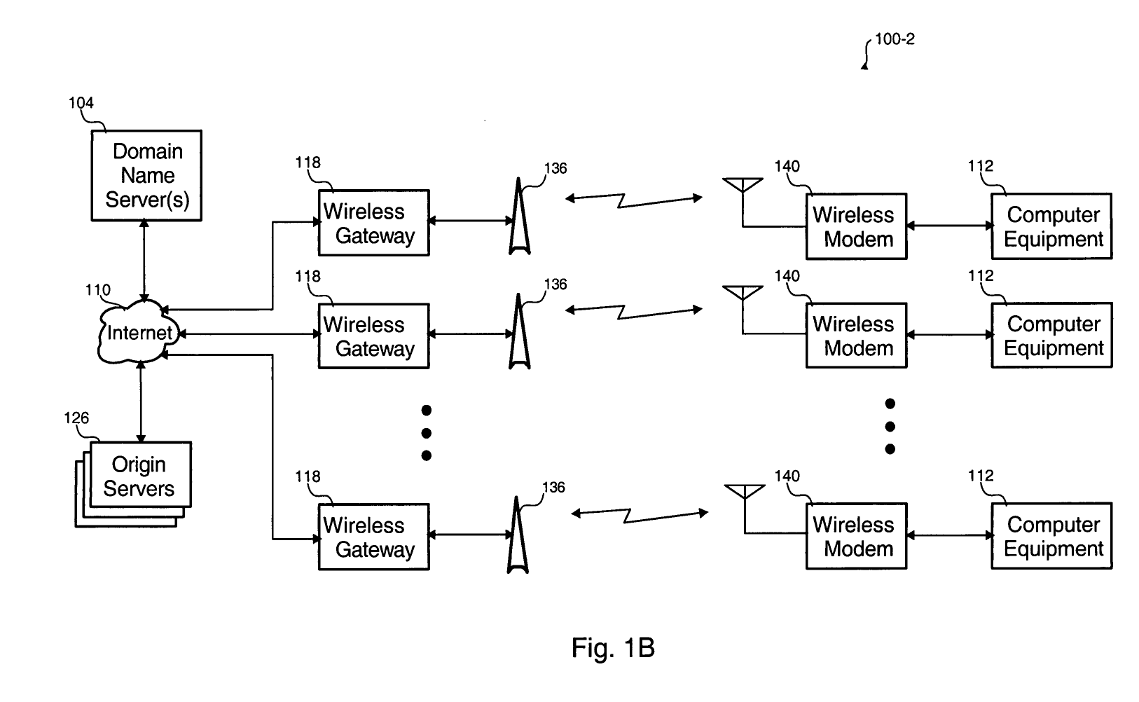

Referring initially to FIG. 1A, a block diagram of an embodiment of a wireless broadband system 100-1 is shown that utilizes a satellite link. A geosynchronous satellite 140 couples a first satellite dish 116 with a second satellite disk 130 in a bi-directional manner. Latency in each direction of this bi-directional link is about 250 ms, but never less than 100 ms or 200 ms in various embodiments. Some embodiments use the satellite link in a single direction and some other media for the other direction, for example, a dial-up modem connection. One embodiment uses a constellation of low earth orbit satellites that are not geosynchronous in the satellite link. In another embodiment, multiple satellites can route amongst themselves before downlinking to a gateway or ground station 118.

The wireless broadband system 100 allows computer equipment 112 of a user or business to communicate with the Internet 110. The computer equipment 112 could include any personal computers, mainframes, workstations, VoIP terminals, PDAs, consumer equipment, business machines, networks, video equipment, etc. that might communicate with the Internet 110. Included in the computer equipment 112 is at least one web browser application. The web browser is configured to use an explicit proxy which could be limited to a protocol used by the web browser by the computer equipment 112. In some embodiments, an implicit proxy could sift through all the TCP/IP information to select only the web browser information.

The computer equipment 112 communicates with a satellite modem 122. The satellite modem 112 appears as an explicit proxy to the computer equipment. The web browser or operating system may have to be configured to use the satellite modem 122 as a proxy. Although the satellite modem 122 appears as a proxy to the computer equipment 112, the proxy functions are split between the satellite modem 122 and the satellite gateway 118 as explained further below.

The satellite modem 122 in this embodiment is a stand-alone unit. It includes software, hardware and one or more processors that implement the functionality of the modem 122. Storage could be in the form of volatile or non-volatile memory. The cache(s) in the modem 122 could be implemented in non-volatile magnetic or optical memory or volatile solid-state memory. In some embodiments, the cache(s) are lost upon power loss. The gateway 118 is notified upon power-up that the cache(s) have been cleared and a process begins to repopulate the pre-storage.

The satellite modem 122 includes ports to communicate with the computer equipment 112 and the satellite dish 116. The port(s) for the computer equipment 112 could include USB, ethernet, IrDA, Firewire, WiFi, UWB, WiMax, carrier current, etc. for various satellite modem 122 configurations. The satellite port allows communication with the satellite dish 116. RF signals are typically used for this port, but some embodiments could use a digital interface.

The satellite gateway 118 communicates between the satellite dish(es) 130 and the Internet 110 to service Internet requests of the computer equipment 112. Various embodiments could have a number of satellite gateways 118 distributed in various ways. One embodiment could receive the requests from various locations and send them to a gateway 118 at some remote location. Other embodiments could use a gang of gateways to divide the requests. Any other configuration is possible to perform the functions of the satellite gateway 118.

Standard Internet requests are posed by the satellite gateways 118 to the Internet 110. Domain name servers (DNS) 104 are used to translate domain names into Internet protocol (IP) addresses. The IP addresses correspond to origin servers 126 that serve up the object indicated in a uniform resource identifier (URI). Although not shown, other variations of the types of Internet configurations are possible. For example, the origin server 126 may use content mirrors or content delivery networks.

Implementation of the satellite gateway 118 can take any number of configurations. Computers and servers implement all the digital processing and storage tasks. Routers, switches, gateways, and modems are used to interface with the Internet and various components of the satellite gateway 118. Portions of the satellite gateway 118 can be spread over a geographically disparate network. The RF functions to interface with the satellite dish 130 or other wireless equivalents are implemented in hardware devices designed for that purpose.

Standard Internet requests are posed by the satellite gateways 118 to the Internet 110. Domain name servers (DNS) 104 are used to translate domain names into Internet protocol (IP) addresses. The IP addresses correspond to origin servers 126 that serve up the object indicated in a uniform resource identifier (URI). Although not shown, other variations of the Internet configuration are possible. For example, the origin server 126 may use content mirrors or content delivery networks.

With reference to FIG. 1B, a block diagram of another embodiment of the wireless broadband system 100-2 is shown that utilizes a wireless cellular link. The wireless modems 140 could be plug-in cards that allow various types of computer equipment 112 to communicate with the wireless gateways 118 without necessarily having phone capabilities. In one embodiment, both the wireless modem 140 and computer equipment 112 are integrated into a telephone handset with browser capabilities. Each wireless gateway 118 is coupled to a cellular base station 136 that wirelessly couples to the wireless modem 140. The latency of the cellular link is substantially less than a satellite link in most cases.

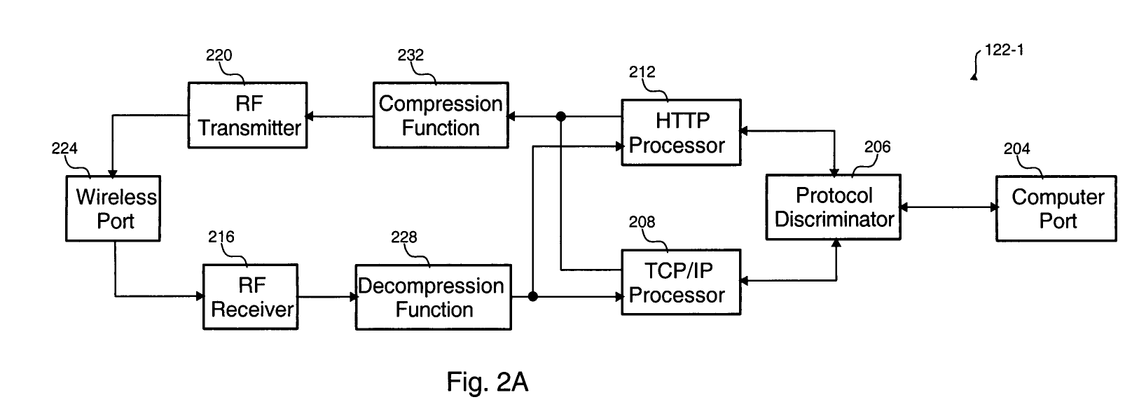

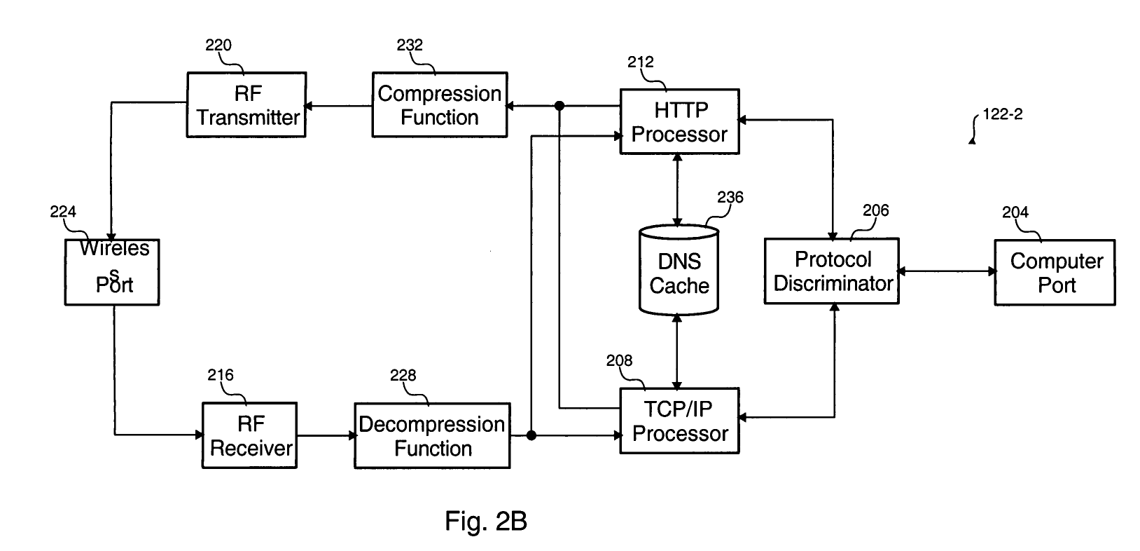

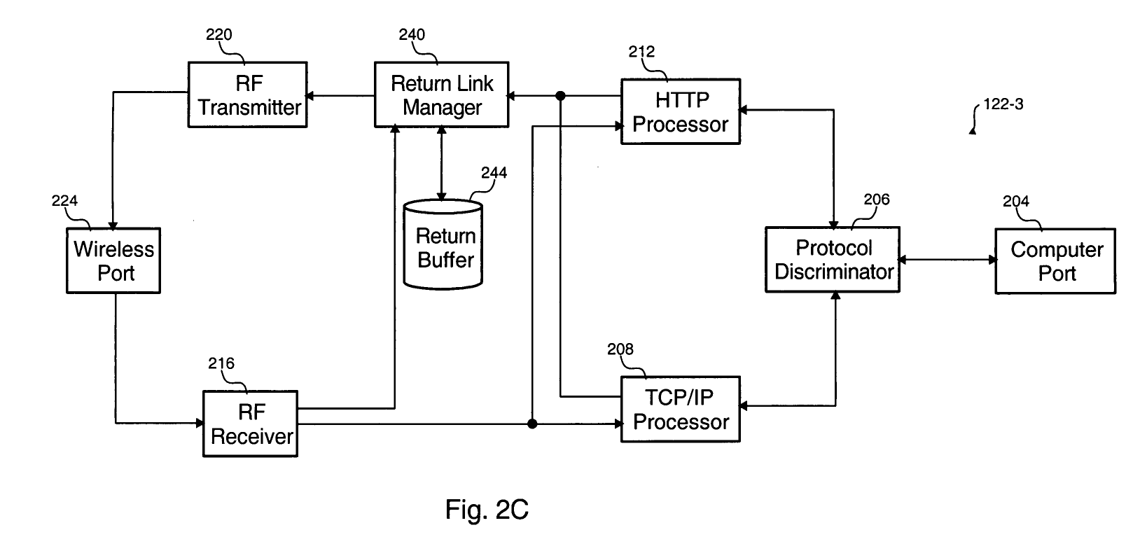

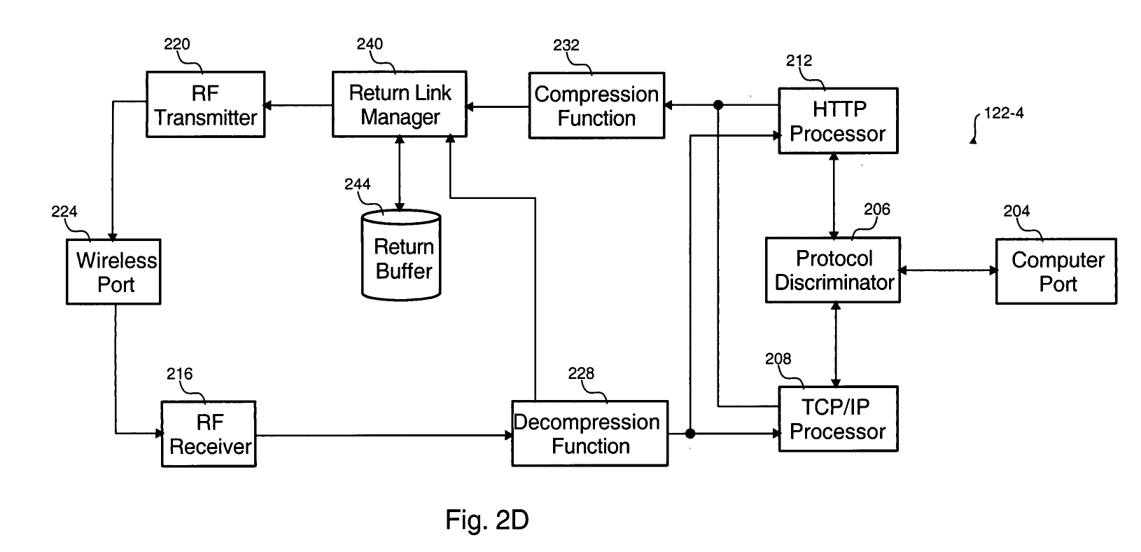

Referring next to FIG. 2A, a block diagram of an embodiment of a satellite or wireless modem 122-1 is shown. A computer port 204 communicates with the computer equipment 112, but other embodiments could support a number of different wired or wireless ports 204 and protocols. A protocol discriminator 206 manages all the TCP/IP traffic of the computer port 204. HTTP type traffic is kept separate from other TCP/IP traffic by the protocol discriminator 206. IP address, port or other mechanisms could be used to keep the HTTP traffic separate from the remainder of the TCP/IP traffic. In any event, the protocol discriminator 206 communicates the HTTP traffic to the HTTP processor 212 and the remaining TCP/IP traffic to the TCP/IP processor 208.

The TCP/IP processor 208 handles Internet traffic that is not HTTP traffic. Some embodiments may enhance the handling of non-HTTP traffic using some of the techniques described herein. The TCP/IP processor communicates over the wireless link in compressed form by using the compression and decompression functions 232, 228. The radio frequency (RF) transmitter 220 and RF receiver 216 modulate and demodulate digital signals onto a carrier frequency. Other embodiments may have different RF configurations.

The HTTP processor 212 manages the HTTP traffic. When HTTP traffic is detected, a TCP connection between the satellite modem 122 and satellite gateway 118 is opened by the HTTP processor in both the forward and return links. After a period of inactivity, this TCP connection could be closed, for example, after 20 minutes. Presuming no inactivity period has triggered a disconnect, many different HTTP transactions will flow through the TCP link. A conventional system would set-up and tear-down a TCP link for each HTTP transaction. The HTTP processor 212 gathers HTTP GETs from the computer equipment 112 and supplies the corresponding HTTP REPLY.

Some embodiments could use protocols other than TCP for the forward and/or return links. These protocols are configured in advance of receiving the HTTP transaction and remain open to service many HTTP transactions. Typically, a RTT delay is used to configure the protocol for the return link, but this embodiment only suffers that RTT delay the first time the return link is configured.

The forward and return links use compression to reduce the bandwidth requirements. The compression algorithm is tailored to the specific data in this embodiment. For example, one algorithm may be used for text and another for files. The data passing through the return link is largely text such an effective textual algorithm is used, for example, Lempel-Ziv. The forward link may use another algorithm that is effective for textual and non-textual information. In any event, but the compression and decompression functions 232, 228 use lossless compression in this embodiment. The compression and decompression functions 232, 228 could be implemented in hardware and/or software. Where multiple algorithms are used, a header for the compressed data can indicate which algorithm was used for the compressed data to allow the receiving end of the link to decompress the data.

With reference to FIG. 2B, a block diagram of another embodiment of the satellite or wireless modem 122-2 is shown that includes a DNS cache 236. The DNS cache 236 is used by the HTTP processor 212 and TCP/IP processor 208 to hold previously obtained DNS look-ups that used the gateway 118. When a web browser or other application requests a DNS look-up, the DNS cache can be referenced to determine if it has been determined previously. Any cached IP address can be used for a subsequent DNS look-up operation.

Referring next to FIG. 2C, a block diagram of yet another embodiment of a modem 122-3 is shown that includes bandwidth management for the return link. A return buffer 224 holds the data destined for the return link until it can be spooled out by a return link manager 240. The return link is nominally a 20-40 Kbps channel that is always available to the return link manager 240.

Should the return buffer 224 begin to fill to a point that would increase the latency of the return link, the bandwidth can be scaled-up for a period of time. The return link manager 240 can request more bandwidth or just report the fill level to the gateway 118. The gateway 188 can evaluate the request and assign a higher bandwidth for a period of time before the return link would revert to a lower bandwidth channel. In a CDMA topology this could include sending a new channel code that had higher bandwidth, but any topology could be used in various embodiments (TDMA, etc.).

With reference to FIG. 2D, a block diagram of still another embodiment of a modem 122-4 is shown that includes both bandwidth management and compression. In this embodiment, the contents of the return buffer 244 are compressed before sending them over the return link. Since all the information in the return buffer is destined for the gateway 118, the same TCP connection can be used for all the information rather than setting-up and tearing down separate connections. Some embodiments could use protocols other than TCP that can open a persistent connection and manage the transfer of packets of information.

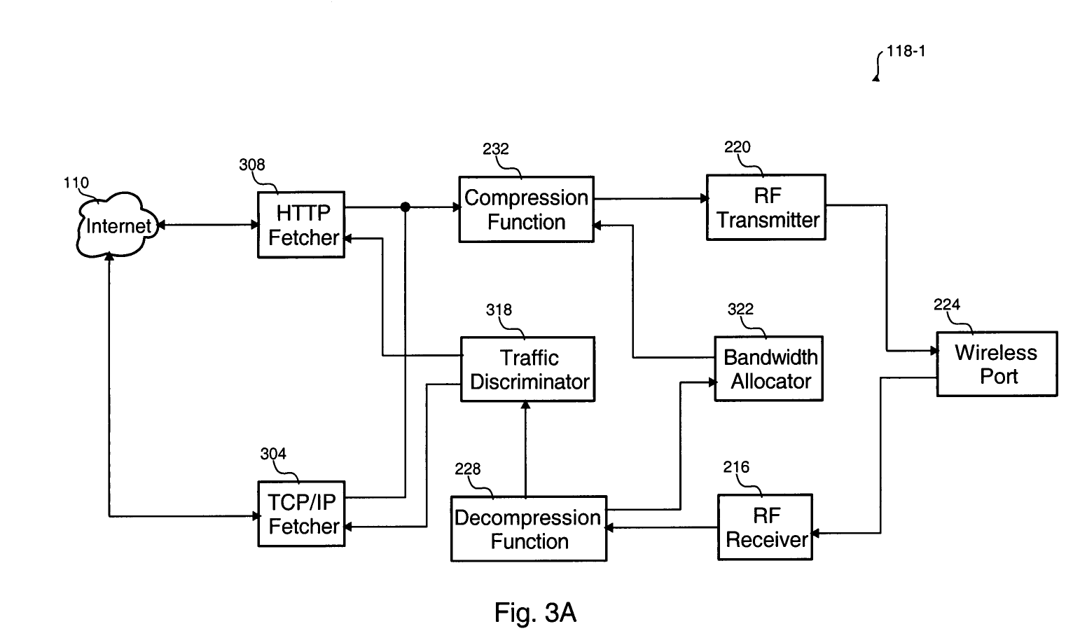

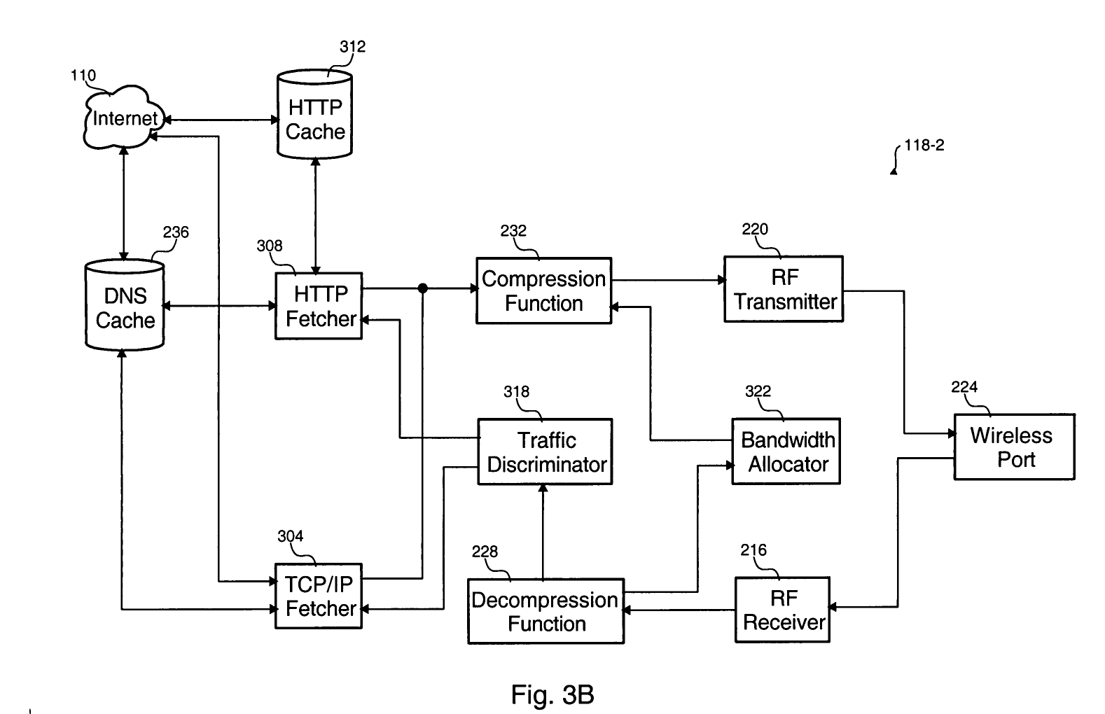

Referring next to FIG. 3A, a block diagram of an embodiment of a satellite or wireless gateway 118-1 is shown. The depicted embodiment uses the compression function 232, the decompression function 228, the RF transmitter 220, the RF receiver 216, and wireless port 224 in a configuration that mirrors the wireless modem 122. Once information from the return link is demodulated and decompressed, a traffic discriminator 318 determines if the information is HTTP related. The HTTP fetcher 308 handles the HTTP traffic and a TCP/IP fetcher 304 handles the remainder. Both HTTP and TCP/IP fetchers 308, 304 interact with the Internet 110 to gather and return Internet information for the forward link to the modem 122.

The HTTP fetcher 308 decodes the URIs with their domain names that are received from the modem 122. The domain name is translated to an IP address using a DNS 104 on the Internet 110. Once the IP address is known, the URI is issued to the particular origin server 126 to provide the HTTP object. The requested object and subsequently requested embedded objects are compressed and sent on the forward link as they arrive. Other embodiments of the HTTP fetcher follow all the embedded links in a web page object and also sends those linked pages to the HTTP processor 212 in anticipation of one of the linked pages being requested.

A bandwidth allocator 322 receives requests for additional return bandwidth from the various modems 122 in the wireless broadband system 100. These requests could be asking for a certain amount of bandwidth or could just be a report of the fill level in the return buffer 224. The fill level could be the amount of data buffered or could indicate how much of the buffer 224 is consumed. In one embodiment two bits are used in a header of a packet from a modem 122 to indicate if three different thresholds are reached in the buffer, for example, one-third full, two-thirds full and nearly full.

With reference to FIG. 3B, a block diagram of another embodiment of a satellite or wireless gateway 118-2 is shown. This embodiment integrates a HTTP cache 312 and DNS cache 236 into the gateway 118-2. As the many modems 122 request objects, the DNS information and HTTP pages are stored. Subsequent requests for the same information can be served from the caches 236, 312. The TCP/IP and HTTP fetchers 304, 308 use the DNS cache 236 and the HTTP fetcher 308 uses the HTTP cache 312. The HTTP cache 312 only returns unparameterized information that is not unique to any one user since many objects are customized.

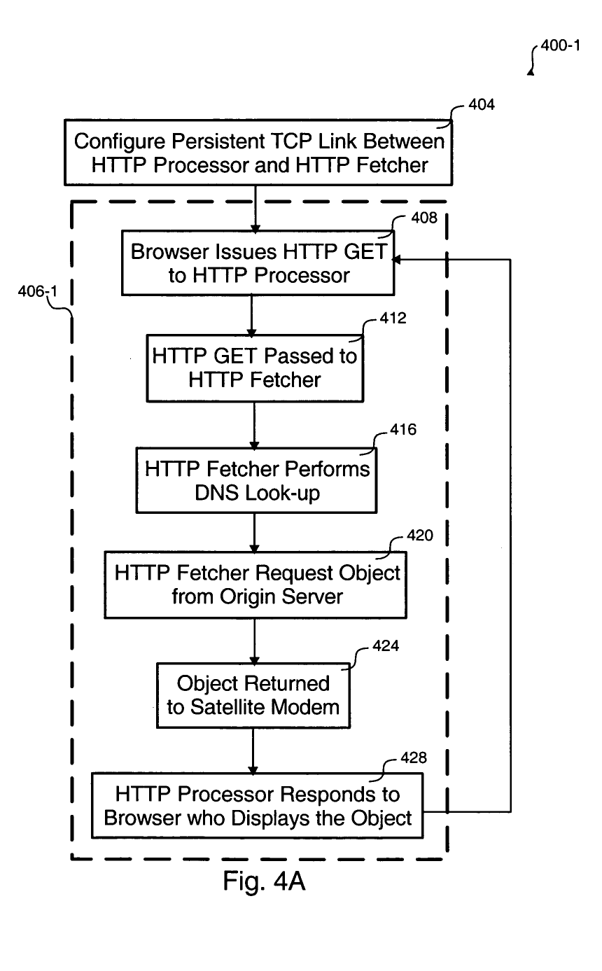

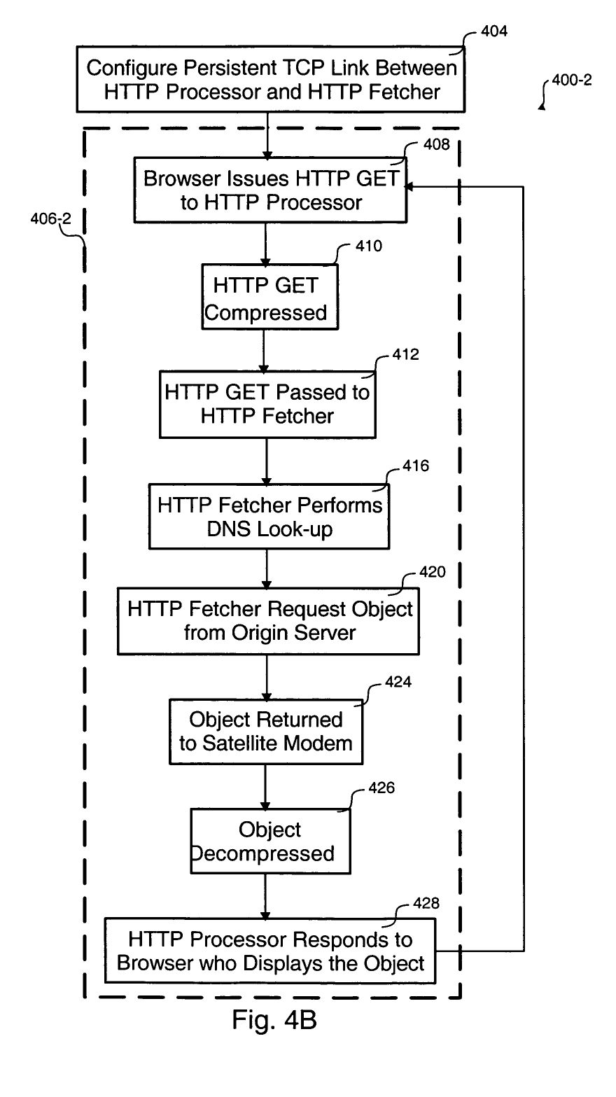

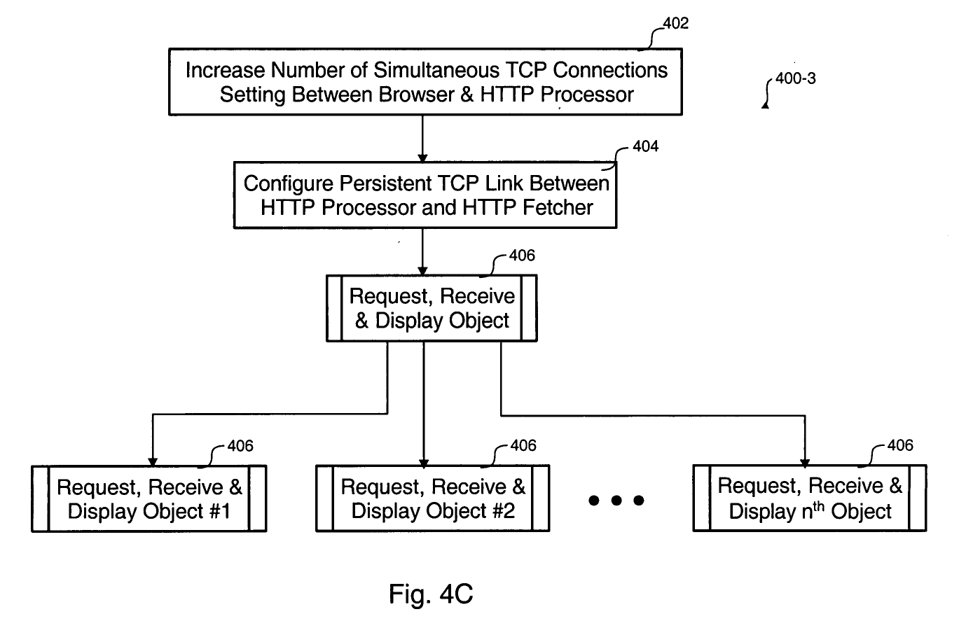

Referring next to FIG. 4A, a flow diagram of an embodiment of a process 400-1 for downloading an object over a wireless link is shown. The depicted portion of the process 400-1 begins in step 404 where a persistent TCP link between the modem 122 and gateway 118 is configured before this HTTP GET is issued to the HTTP processor. This TCP link has a limited bandwidth available to service any return link data with low latency. The browser on the computer equipment 112 is configured to use the HTTP processor 212 as a proxy, but the proxy functionality is divided between the HTTP processor 212 and the HTTP fetcher 308.

In step 408, the browser issues a HTTP GET command to the HTTP processor 212. In this embodiment, the browser defers the DNS lookup and handling of external IP addresses to the HTTP processor 212. The HTTP GET command and associated URI is passed by the return link to the HTTP fetcher 308 in step 412. A DNS lookup is performed by the HTTP fetcher 308 in step 416 to get the IP address of the domain name from the URI.

The object is requested in step 420 from the origin server(s) 126. As the object is sent from the origin server 126, it is forwarded to the HTTP processor 212 using the forward link in step 424. The web browser's original HTTP GET command is fulfilled by the HTTP processor 212 in step 428. Any subsequent HTTP GET commands are satisfied by looping from step 428 back to step 408.

With reference to FIG. 4B, a flow diagram of another embodiment of a process 400-2 for downloading an object over a wireless link is shown. This embodiment supports compression on the forward and return links. A step of compressing the HTTP GET command is performed in step 410 and a step of decompressing the object is performed in step 426. Additional steps in other embodiments could support different compression algorithms that change based upon the protocol, content, application, etc.

With reference to FIG. 4C, a flow diagram for an embodiment of a process 400-3 for downloading a group of objects over a wireless link is shown. In step 402, computer equipment 112 is configured in a non-standard manner to allow more than the recommended maximum amount of HTTP connections to the modem 122. Configuring the computer equipment may involve modifying browser settings, changing registry entries or other configuration. In various embodiments, the number of TCP connections could be at least 5, 10, 16, 32, 64, 128, 256 or any other integer greater than 5.

A TCP or other connection is established over the satellite link in step 404. This TCP connection may have been established with an earlier HTTP GET or could be established as a result of the present HTTP GET. In any event, the TCP connection remains open during the rest of the process 400-3 and perhaps even longer. In this embodiment, a first HTTP GET request for an object with embedded links to other objects is satisfied with a HTTP REPLY in step 406. This would involve configuring a TCP connection between the computer equipment 112 and the modem 122.

Once the first object is returned in the HTTP REPLY, a number of embedded links are extracted by the computer equipment 112. With the non-standard number of HTTP connections available, all the embedded links can be requested in the number of 406 steps in a parallel fashion. A particular web browser may sequentially issue the HTTP GET commands in quick succession, but could continue to issue these HTTP GET commands because of the increased number of HTTP connections available. Should the limit in HTTP connections be reached, the web browser would wait for one of the opened HTTP connections to close out.

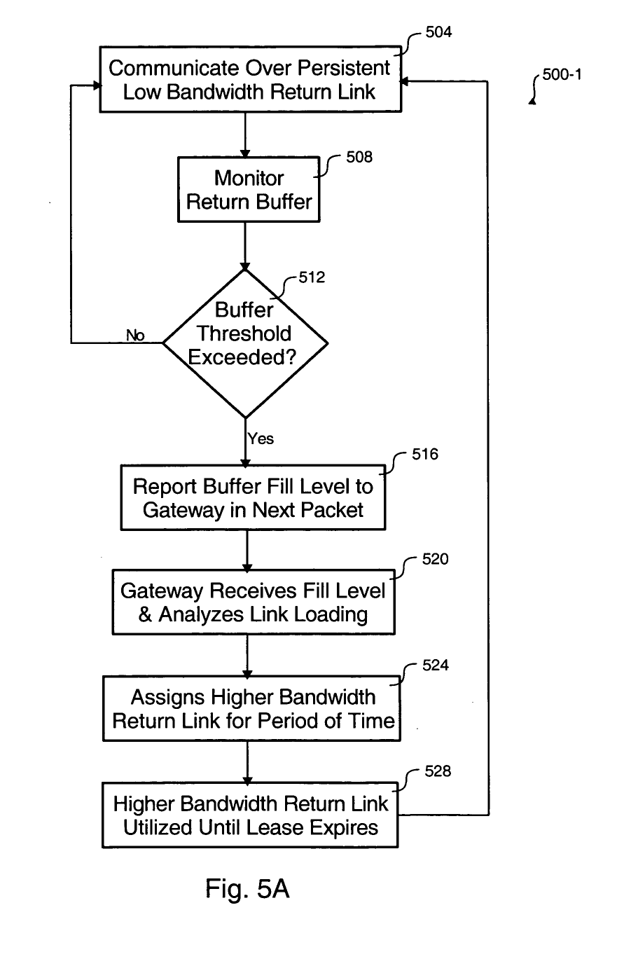

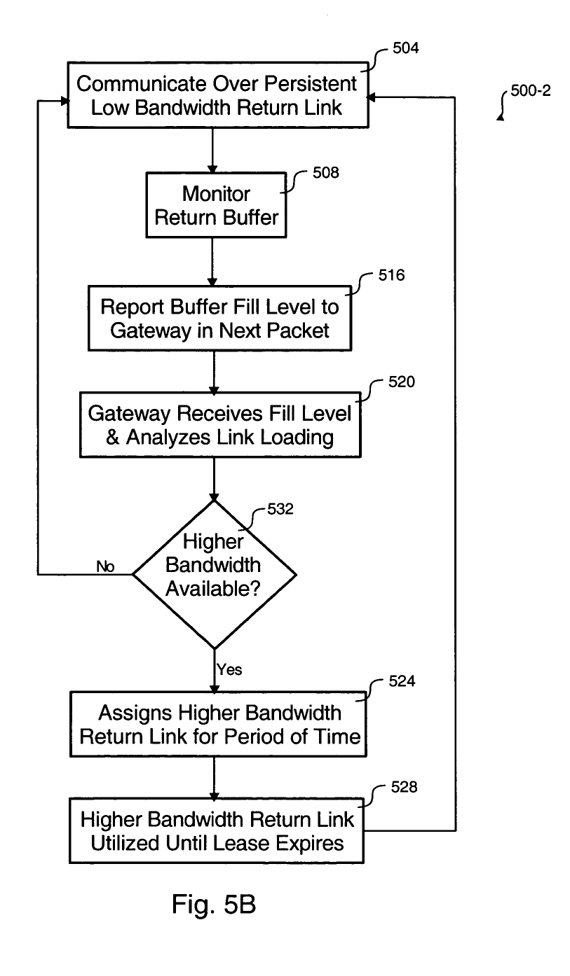

Referring next to FIG. 5A, a flow diagram of an embodiment of a process 500-1 for accelerating a wireless return link in a wireless broadband system 100 is shown. The return link manager 240 works in conjunction with the bandwidth allocator 322 to provide adequate return link bandwidth. The depicted portion of the process 500-1 begins in step 504 communication is performed over a persistent low-bandwidth return link. This embodiment only reports a buffer fill level once a threshold is exceeded, but other embodiments could return buffer status with each packet or periodically with packets.

In step 508, the return buffer consumption is monitored by the return link manager 240. So long as a predetermined threshold is not exceeded in step 512, the return link manager does not request additional bandwidth and processing loops back to step 504. Where the buffer threshold is exceeded in step 512, processing continues to step 516 to request additional bandwidth. In this embodiment, the threshold is the return buffer becoming one third full. Other embodiments define the threshold as a delay to empty the buffer given the current bandwidth allocation. For example, when the buffer will take more than 100 ms to empty, a request for additional bandwidth is made.

In step 516, the buffer fill level is reported to the gateway 118 with the next packet. This report could be an amount in the buffer, a time required to empty the buffer and/or just an indication that the threshold has been exceeded. The bandwidth allocator 322 receives the fill level information in step 520 and analyzes the need of the requesting modem 122 with respect to the need of others sharing the return link. Where all the requests cannot be accommodated, the granting of requests may be randomly allowed, in a round-robin fashion or allowed according to some other fashion such that the latency effect is distributed across all modems 122.

If allowed, the higher-bandwidth return link is assigned in step 524 for a period of time. The higher-bandwidth link could be an additional link or one to replace the prior link. After the period of time expired, another return link could be indicated with a different bandwidth. Any series of links and time periods could be specified by the bandwidth allocator 322. For example, a 750 Kbps link could be allocated immediately for three seconds and a 200 Kbps link could be made available after a two second delay and remain available for ten seconds thereafter. A different allocation of links could be performed later if the bandwidth allocator 322 changes its position by replacing the link(s) with a different one(s) by notifying the modem 122.

The new links are used until the time period definition expires. In some cases, the link has no expiration such that the use can continue until the modem 122 is informed otherwise. For example, the modem may be given a 500 Kbps link for the next ten seconds and a 25 Kbps link thereafter that could be used until the modem 122 receives new instructions.

With reference to FIG. 5B, a flow diagram of another embodiment of a process 500-2 for accelerating a return link in a wireless broadband system 100 is shown. In this embodiment, the fill level is reported with each packet, every few packets or periodically by performing steps 504, 508, 516, and 520 in a loop. In step 532 and after step 520, the bandwidth allocator 322 is determining if addition bandwidth should be made available. If none is made available, processing loops from step 532 back to step 504. Where more is made available as determined in step 532, steps 524 and 528 are performed before looping back to step 504.

The above description of the disclosed embodiments is provided to enable any person skilled in the art to make or use the disclosure. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

1. A method for downloading a hyper text transfer protocol (HTTP) web page over a satellite link that couples a satellite modem to a satellite gateway, the method comprising steps of:
opening a transmission control protocol (TCP) link between the satellite gateway and the satellite modem;
receiving a HTTP uniform resource identifier (URI) at the satellite modem from a web browser, wherein:
the HTTP URI corresponds to the HTTP web page of an origin server, and
the opening step is performed before the receiving step;
sending the HTTP URI to the satellite gateway over the TCP link;
determining an Internet protocol (IP) address for a domain name indicated in the HTTP URI by the satellite gateway;
retrieving the HTTP web page, wherein:
the retrieving step is caused by the sending step, and
the HTTP web page comprises a plurality of embedded URIs;
transmitting the HTTP web page to the satellite modem;
sending at least five of the plurality of embedded URIs to the satellite gateway over the TCP link, wherein the at least five correspond to five objects; and
transmitting the five objects to the satellite modem, wherein the satellite gateway has the at least five, but none of the five objects have been completely transmitted.

2. The method for downloading the HTTP web page over the satellite link that couples the satellite modem to the satellite gateway as recited in claim 1, further comprising a step of compressing the HTTP URI before the sending step.

3. The method for downloading the HTTP web page over the satellite link that couples the satellite modem to the satellite gateway as recited in claim 1, further comprising a step of sending the IP address away from the satellite modem.

4. The method for downloading the HTTP web page over the satellite link that couples the satellite modem to the satellite gateway as recited in claim 1, wherein the satellite modem appears to include an explicit proxy from the perspective of the web browser.

5. The method for downloading the HTTP web page over the satellite link that couples the satellite modem to the satellite gateway as recited in claim 1, further comprising a step of distinguishing the HTTP URI from other Internet requests.

6. The method for downloading the HTTP web page over the satellite link that couples the satellite modem to the satellite gateway as recited in claim 1, further comprising a step of sending the web page away from the satellite modem.

7. A computer-readable medium having computer-executable instructions for performing the computer-implementable method for downloading the HTTP web page over the satellite link of claim 1.

8. A wireless downloading system for sending a HTTP web page over a wireless link, the wireless downloading system comprising:
a wireless modem that receives a HTTP URI from a web browser; and
a wireless gateway remotely located from the wireless modem, wherein:
the HTTP URI corresponds to the HTTP web page of an origin server,
a protocol link couples the wireless modem and the wireless gateway; and
the protocol link is opened before the wireless modem receives the HTTP URI,
the HTTP URI is sent to the wireless gateway,
an Internet protocol (IP) address is determined by the wireless gateway for a domain name indicated in the HTTP URI,
the HTTP web page is retrieved by the wireless gateway using the Internet, and
the HTTP web page is transmitted to the wireless modem without the wireless modem taking any action beyond sending the HTP URI to the wireless gateway.

9. A method for downloading a HTTP web page over a wireless link between a wireless modem and a point away from the wireless modem, the method comprising steps of:
opening a TCP link between the wireless modem and the point;
receiving a HTTP URI at the wireless modem from a web browser, wherein:
the HTTP URI corresponds to the HTTP web page of an origin server, and
the opening step is performed before the receiving step;
sending the HTTP URI to the point;
accepting the web page from the point without determining the IP address at the wireless modem, wherein the IP address corresponds to the domain indicated in the HTTP URI; and
transmitting the HTTP web page to the web browser.

10. The method for downloading the HTTP web page over the wireless link between the wireless modem and the point away from the wireless modem as recited in claim 9, further comprising a step of determining the IP address for the domain name indicated in the HTTP URI at the point.

11. The method for downloading the HTTP web page over the wireless link between the wireless modem and the point away from the wireless modem as recited in claim 9, further comprising a step of retrieving the web page at the point.

12. The method for downloading the HTTP web page over the wireless link between the wireless modem and the point away from the wireless modem as recited in claim 9, wherein the point corresponds to a wireless gateway.

13. The method for downloading the HTTP web page over the wireless link between the wireless modem and the point away from the wireless modem as recited in claim 9, wherein a satellite link couples the wireless modem to the point.

14. The method for downloading the HTTP web page over the wireless link between the wireless modem and the point away from the wireless modem as recited in claim 9, wherein a cellular base station couples the wireless modem to the point.

15. The method for downloading the HTTP web page over the wireless link between the wireless modem and the point away from the wireless modem as recited in claim 9, further comprising a step of compressing the HTTP URI.

16. The method for downloading the HTTP web page over the wireless link between the wireless modem and the point away from the wireless modem as recited in claim 9, further comprising a step of determining if the IP address for the domain is cached within the wireless modem.

17. A computer-readable medium having computer-executable instructions for performing the computer-implementable method for downloading the HTTP web page over the wireless link between the wireless modem and the point away from the wireless modem of claim 9.

18. An electronic system adapted to perform the computer-implementable method for downloading the HTTP web page over the wireless link between the wireless modem and the point away from the wireless modem of claim 9.

19. A method for retrieving a HTTP web page requested from a wireless link between a wireless gateway and a point away from the wireless gateway, the method comprising steps of:
opening a protocol link between the wireless gateway and the point that uses packet switching;
receiving a HTTP URI at the wireless gateway from the point, wherein:
the HTTP URI corresponds to the HTTP web page of an origin server, and
the protocol link is opened before the HTTP URI is formulated at the point;
determining the IP address for the domain name indicated in the HTTP URI;
retrieving the web page from the IP address; and
transmitting the HTFP web page to the point, wherein the IP address is not transmitted to the point.

20. The method for retrieving the HTTP web page requested from the wireless link between the wireless gateway and the point away from the wireless gateway as recited in claim 19, wherein the point corresponds to a wireless modem.

21. The method for retrieving the HTTP web page requested from the wireless link between the wireless gateway and the point away from the wireless gateway as recited in claim 19, further comprising steps of:
receiving a plurality of embedded URIs, wherein the embedded URIs are associated with the HTTP web page;
retrieving a plurality of objects that correspond to the plurality of embedded URIs; and
transmitting the plurality of objects to the point, wherein at least five of the plurality of objects have been requested in the immediately preceding retrieving step, but not completely sent in the transmitting step.

22. The method for retrieving the HTTP web page requested from the wireless link between the wireless gateway and the point away from the wireless gateway as recited in claim 19, wherein a satellite link couples the wireless gateway to the point.

23. The method for retrieving the HTTP web page requested from the wireless link between the wireless gateway and the point away from the wireless gateway as recited in claim 19, wherein a cellular base station couples the wireless gateway to the point.

24. The method for retrieving the HTTP web page requested from the wireless link between the wireless gateway and the point away from the wireless gateway as recited in claim 19, further comprising a step of decompressing the HTTP URI.

25. A computer-readable medium having computer-executable instructions for performing the computer-implementable method for retrieving the HTTP web page requested from the wireless link between the wireless gateway and the point away from the wireless gateway of claim 19.

26. An electronic system adapted to perform the computer-implementable method for retrieving the HTTP web page requested from the wireless link between the wireless gateway and the point away from the wireless gateway of claim 19.

27. A wireless downloading system for retrieving a HTTP web page requested from a wireless link between a wireless gateway and a point away from the wireless gateway, the wireless downloading system comprising:
means for opening a TCP link between the wireless gateway and the point;
means for receiving a HTTP URI at the wireless gateway from the point, wherein:
the HTTP URI corresponds to the HTTP web page of an origin server, and
the TCP link is opened before the HTTP URI is formulated at the point;
means for determining the IP address for the domain name indicated in the HTTP URI;
means for retrieving the web page from the IP address; and
means for transmitting the HTTP web page to the point, wherein the IP address is not transmitted to the point.

28. The wireless downloading system for retrieving the HTTP web page requested from the wireless link between the wireless gateway and the point away from the wireless gateway as recited in claim 27, further comprising means for closing the TCP link after a period of inactivity for the TCP link.

29. A wireless system for downloading Internet information, the wireless system comprising:
a wireless modem having a return link buffer;
a wireless gateway;
a persistent datalink coupling the wireless modem with the wireless gateway, wherein:
the persistent datalink has a first return link bandwidth that is dedicated for the wireless modem,
the wireless gateway can modify the persistent datalink to have a second return link bandwidth based at least in part upon a loading of the return link buffer, and
the first return link bandwidth is less than the second return link bandwidth.

30. The wireless system for downloading Internet information as recited in claim 29, wherein the persistent datalink has a forward link having greater bandwidth than a first or second return link bandwidth.

31. The wireless system for downloading Internet information as recited in claim 29, wherein the persistent datalink has a forward link shared by a plurality of wireless modems.

32. The wireless system for downloading Internet information as recited in claim 29, wherein the persistent datalink includes a satellite.

33. The wireless system for downloading Internet information as recited in claim 29, wherein the persistent datalink includes a cellular base station.

34. The wireless system for downloading Internet information as recited in claim 29, wherein the persistent datalink has a return link that carries compressed textual information.

35. The wireless system for downloading Internet information as recited in claim 29, wherein the persistent datalink has a return link that carries a compressed HTTP URI.

36. A method for managing a wireless datalink used for passing Internet information between a wireless modem and a wireless gateway, the method comprising steps of:
coupling the wireless modem with the wireless gateway with a return link, wherein the return link has a first bandwidth that is dedicated for the wireless modem;
determining a backlog size of information in the wireless modem that is destined for the return link; and
allocating additional bandwidth to the return link, wherein the return link is assigned the additional bandwidth for a period of time.

37. The method for managing the wireless datalink used for passing Internet information between the wireless modem and the wireless gateway as recited in claim 36, wherein the determining step comprises a step of determining that the backlog size has reached a predetermined threshold.

38. The method for managing the wireless datalink used for passing Internet information between the wireless modem and the wireless gateway as recited in claim 36, further comprising a step of notifying the wireless gateway of the backlog size.

39. The method for managing the wireless datalink used for passing Internet information between the wireless modem and the wireless gateway as recited in claim 36, further comprising a step of notifying the wireless gateway that the backlog size has reached a predetermined threshold.

40. The method for managing the wireless datalink used for passing Internet information between the wireless modem and the wireless gateway as recited in claim 36, further comprising a step of compressing data for the return link.

41. The method for managing the wireless datalink used for passing Internet information between the wireless modem and the wireless gateway as recited in claim 36, further comprising a step of compressing HTTP information for the return link.

42. The method for managing the wireless datalink used for passing Internet information between the wireless modem and the wireless gateway as recited in claim 36, further comprising steps of:
discovering data is textual; and
compressing the data based upon the discovering step.

43. A computer-readable medium having computer-executable instructions for performing the computer-implementable method for managing the wireless datalink used for passing Internet information between the wireless modem and the wireless gateway of claim 36.

44. A broadband system for managing a wireless datalink used for passing Internet information between a wireless modem and a wireless gateway, the broadband system comprising:
means for coupling the wireless modem with the wireless gateway with a return link, wherein the return link has a first bandwidth that is dedicated for the wireless modem;
means for determining a backlog size of information in the wireless modem that is destined for the return link; and
means for allocating additional bandwidth to the return link, wherein the return link is assigned the additional bandwidth for a period of time.

45. The broadband system for managing the wireless datalink used for passing Internet information between the wireless modem and the wireless gateway as recited in claim 44, wherein the wireless modem is also coupled with the wireless gateway with a forward link that shared by a plurality of wireless modems.

46. The broadband system for managing the wireless datalink used for passing Internet information between the wireless modem and the wireless gateway as recited in claim 44, wherein the return link includes a satellite.

47. The broadband system for managing the wireless datalink used for passing Internet information between the wireless modem and the wireless gateway as recited in claim 44, wherein the return link includes a cellular base station.

48. The broadband system for managing the wireless datalink used for passing Internet information between the wireless modem and the wireless gateway as recited in claim 44, wherein the return link carries compressed textual information.

49. The broadband system for managing the wireless datalink used for passing Internet information between the wireless modem and the wireless gateway as recited in claim 44, wherein the latency of the return link travel time is never less than looms.

50. The broadband system for managing the wireless datalink used for passing Internet information between the wireless modem and the wireless gateway as recited in claim 44, wherein the latency of the return link travel time is never less than 200 ms.
